(19) United States
(12) Patent Application Publication
(10) Pub. No.: US 2025/0056564 A1
(43) Pub. Date: Feb. 13, 2025

(54) DCI DESIGN FOR SUPPORTING SINGLE DCI SCHEDULING MULTIPLE CELLS

(71) Applicant: Apple Inc., Cupertino, CA (US)

(72) Inventors: Haitong SUN, Cupertino, CA (US); Chunxuan YE, San Diego, CA (US); Dawei ZHANG, Saratoga, CA (US); Huaning NIU, San Jose, CA (US); Oghenekome OTERI, San Diego, CA (US); Sigen YE, San Diego, CA (US); Wei ZENG, Saratoga, CA (US); Yushu ZHANG, Beijing (CN)

(21) Appl. No.: 18/929,428

(22) Filed: Oct. 28, 2024

Related U.S. Application Data
(63) Continuation of application No. PCT/CN2022/090374, filed on Apr. 29, 2022.

(51) Int. Cl. H04W 72/232

(52) U.S. Cl. CPC H04W 72/232

(57) ABSTRACT

Embodiments of the present disclosure relate to DCI design for supporting a single DCI scheduling PUSCHs on multiple cells. According to embodiments of the present disclosure, a processor of a base station is configured to perform operations comprising configuring a single DCI to schedule PUSCHs on multiple cells simultaneously, and transmitting the single DCI to a user equipment over a PDCCH.

### CROSS-REFERENCE TO RELATED APPLICATIONS

The present application is a continuation of International Application PCT/CN2022/090374, with an international filing date of Apr. 29, 2022, of the same title, the contents of all of which are incorporated by reference herein in their entirety for all purposes.

### TECHNICAL FIELD

Embodiments of the present disclosure generally relate to the field of telecommunications, and in particular, to Downlink Control Information (DCI) design for supporting a single DCI scheduling Physical Uplink Shared Channel (PUSCH) on multiple cells.

### BACKGROUND

In the Current New Radio (NR) Including 3GPP Rel-15/16/17, a Single DCI can Only be Used to Schedule Scheduling a PUSCH on One Cell.

### SUMMARY

In general, example embodiments of the present disclosure provide a solution for supporting a single DCI scheduling PUSCHs on multiple cells.

In a first aspect, there is provided a processor of a base station (BS). The processor is configured to perform operations comprising configuring a single DCI to schedule PUSCHs on multiple cells simultaneously; and transmitting the single DCI to a user equipment (UE) over a Physical Downlink Control Channel (PDCCH).

In a second aspect, there is provided a base station. The base station comprises a transceiver and a processor. The transceiver is configured to communicate with a user equipment. The processor is communicatively coupled to the transceiver and configured to perform operations comprising configuring a single DCI to schedule PUSCHs on multiple cells simultaneously; and transmitting the single DCI to a user equipment over a PDCCH.

In a third aspect, there is provided a processor of a user equipment. The processor is configured to perform operations comprising receiving, form a network over a PDCCH, a single DCI; and transmitting in PUSCHs on multiple cells based on the configuration information included in the single DCI.

In a fourth aspect, there is provided a user equipment. The user equipment comprises a transceiver and a processor. The transceiver is configured to communicate with a network. The processor is communicatively coupled to the transceiver and configured to perform operations comprising receiving, form a network over a PDCCH, a single DCI; and transmitting in PUSCHs on multiple cells based on the configuration information included in the single DCI.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates a signaling flow for enabling using a single DCI to schedule multiple cells according to some embodiments of the present disclosure;

FIG. 3 illustrates a schematic diagram of an offset of starting symbols of the scheduled cells given that the mapping types and duration of the PUSCH are the same for the scheduled cells, according to some embodiments of the present disclosure;

FIG. 4 illustrates a flowchart illustrating an example method of supporting a single DCI scheduling PUSCHs on multiple cells performed by the BS according to some embodiments of the present disclosure;

FIG. 5 illustrates a flowchart illustrating an example method of supporting a single DCI scheduling PUSCHs on multiple cells performed by the UE according to some embodiments of the present disclosure; and

FIG. 6 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As mentioned above, in the current NR including Rel-15/16/17, a single DCI can only be used to schedule a PUSCH on one cell. The scheduled cell may be indicated by a “Carrier indicator” field in the DCI. Mapping of the “Carrier indicator” to the actual cell may be configured by Radio Resource Control (RRC) via CrossCarrierSchedulingConfig, and the configuration may be per scheduled cell.

In Rel-18 that is about to start, in the approved Work Item Description (WID), i.e., RP-213577, on Multi-carrier enhancements, it was agreed to support a single DCI scheduling Physical Downlink Shared Channel (PDSCH)/PUSCH from multiple cells.

The motivation of single DCI to schedule multiple cells is to reduce the PDCCH overhead, i.e., reducing the DCI size. However, except for a few DCI fields such as Cyclic Redundancy Check (CRC), it is a trade-off between scheduling flexibility and DCI size reduction. We may consider a plurality of uplink DCI fields, such as the DCI fields in DCI Format 0_1 and 0_2 of TS38.212.

Embodiments of the present disclosure propose design choices for a single DCI scheduling PUSCHs in multiple cells, including the design for at least: a new DCI/DCI format, an Uplink (UL), or Normal Uplink (NUL))/Supplemental Uplink (SUL) indicator, Frequency Domain Resource Assignment (FDRA), Time Domain Resource Assignment (TDRA), a Sounding Reference Signal (SRS) resource indicator, a Channel State Information (CSI) request, a UL Shared Channel (UL-SCH) indicator, and Miscellaneous such as any one or more fields in DCI Format 0_1, 0_2.

In this solution, a processor of a base station is configured to configure a single DCI to schedule PUSCHs on multiple cells simultaneously, and transmit the single DCI to a user equipment over a PDCCH. The single DCI may be configured with one or more designs of the DCI fields or format. A processor of the user equipment is configured to receive the single DCI form a network (e.g., the base station) over the PDCCH, and transmit in the PUSCHs on multiple cells based on the configuration information included in the configured single DCI.

According to embodiments of the present disclosure, the DCI is designed to support a single DCI scheduling PUSCHs in multiple cells. In this way, the DCI size is reduced and thus the PDCCH overhead is reduced correspondingly. Meanwhile, the scheduling flexibility can be maintained by various proposed DCI designs.

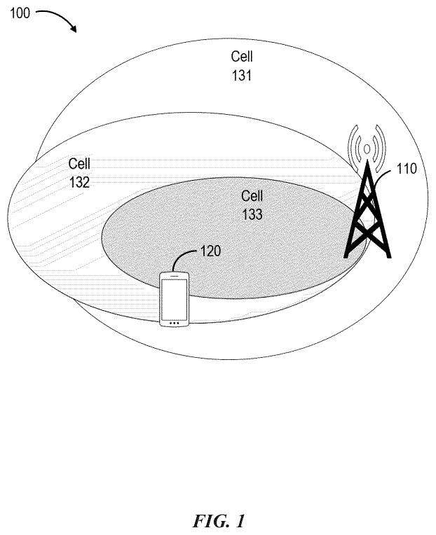

Principle and implementations of the present disclosure will be described in detail below with reference to FIGS. 1-6. FIG. 1 shows an example communication network 100 in which embodiments of the present disclosure can be implemented. The network 100 includes a base station (BS) 110 and user equipment (UE) 120 served by the BS 110. The network 100 may provide multiple serving cells 131-133 to serve the IE 120.

It is to be understood that the number of BS 110, UE 120 and serving cells 131-133 is only for the purpose of illustration without suggesting any limitations. The network 100 may include any suitable number of BS, UE and serving cells adapted for implementing embodiments of the present disclosure.

In the communication network 100, the BS 110 can communicate data and control information to the UE 120 and the UE 120 can also communication data and control information to the BS 110. A link from the BS 110 to the UE 120 is referred to as a downlink (DL) or a forward link, while a link from the UE 120 to the BS 110 is referred to as an uplink (UL) or a reverse link.

Further, in the communication network 100, the BS 110 can transmit a single DCI to the UE 120 over a PDCCH to schedule PUSCHs on multiple cells 131-133. The DCI can be configured by the BS 110 with one or more designs of the DCI fields or format. The UE 120 can receive the single DCI over the PDCCH and transmit in the PUSCHs on multiple cells based on the configuration information included in the configured single DCI.

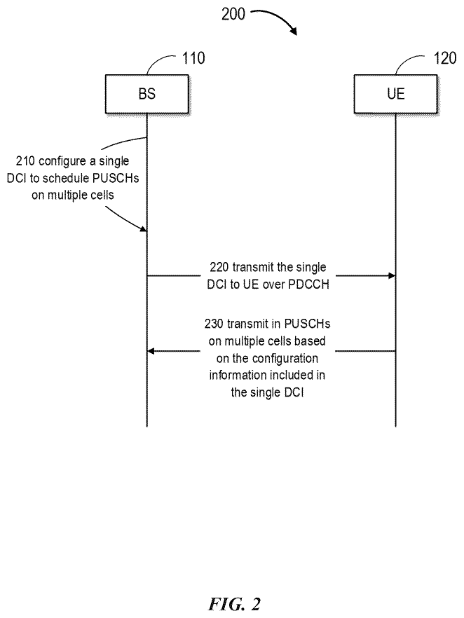

The procedure of the present disclosure will be described with reference to FIG. 2. FIG. 2 illustrates a signaling flow 200 for enabling using a single DCI to schedule multiple cells according to some embodiments of the present disclosure. For the purpose of discussion, the signaling flow 200 will be described with reference to FIG. 1. The signaling flow 200 may involve a BS 110, a UE 120 and multiple cells 131-133 to be scheduled.

In the signaling flow 200, the BS 110 configures 210 a single DCI to schedule PUSCHs on multiple cells. The single DCI can be configured with one or more designs of the DCI fields or format.

In some embodiments, a new DCI can be defined based on a new Radio Network Temporary Identifier (RNTI), i.e., the BS 110 may configure the new RNTI via RRC. Specifically, the BS 110 may define a new RNTI, e.g., a Multi-Cell RNTI (MC-RNTI), to scramble of the CRC of the single DCI that schedules multiple cells simultaneously.

In some embodiments, a new DCI format for uplink scheduling can be defined, i.e., DCI format 0_3. Each DCI field in the new DCI format 0_3 can be designed to indicate the scheduling information of multiple scheduled cells simultaneously.

In some embodiments, the existing DCI format can be used. For example, the DCI format 0_1 or 0_2 can be concatenated to form the new DCI. In this case, when multiple cells 131-133 can be scheduled by a single DCI, for each scheduled cell, the corresponding DCI field size can be configured independently. Then, the DCI from multiple cells can be concatenated to form the final DCI.

Alternatively or in addition, a UL indicator field in the DCI may be configured for scheduling uplink channels such as, but not limited to, PUSCH on multiple cells.

In some embodiments, a single “UL/SUL indicator” field may be included in the single DCI. On each scheduled cell, based on the single “UL/SUL indicator” field, either UL (i.e., NUL) or SUL may be used for all the schedule cells 131-133 based on the single “UL/SUL indicator” field.

In some embodiments, multiple “UL/SUL indicator” fields may be included in the single DCI. In this case, the number of bits of the “UL/SUL indicator” fields may be the maximum number of cells that the single DCI can schedule. Alternatively, the number of bits of the “UL/SUL indicator” fields may be the maximum number of SULs that the single DCI can schedule. Alternatively, the number of bits of the “UL/SUL indicator” fields may be, for each “Carrier indicator”, the number of SULs that the single DCI can schedule.

For example, assuming that a component carrier (CC) 0 (CC0) and CC1 have both NUL and SUL, and CC2 and CC3 have only NUL, if “Carrier indicator”=0 represents to CC0+CC1, “Carrier indicator”=1 represents to CC2+CC3, “Carrier indicator”=2 represents to CC0+CC2 and “Carrier indicator”=3 represents to CC0+CC1+CC2+CC3, then: in the case that the number of bits of the “UL/SUL indicator” fields is the maximum number of cells that the single DCI can schedule, the “UL/SUL indicator” fields can be 4 bits; in the case that the number of bits of the “UL/SUL indicator” fields is the maximum number of SULs that the single DCI can schedule, the “UL/SUL indicator” fields can be 2 bits; and in the case that the number of bits of the “UL/SUL indicator” fields is, for each “Carrier indicator”, the number of SULs that the single DCI can schedule, the “UL/SUL indicator” fields can be 2 bits for “Carrier indicator”=0, 0 bit for “Carrier indicator”=1, 1 bits for “Carrier indicator”=2, and 2 bits for “Carrier indicator”=3.

Alternatively or in addition, a Frequency Domain Resource Assignment (FDRA) field in the DCI may be configured for scheduling uplink channels such as, but not limited to, PUSCH on multiple cells.

In some embodiments, for all the cells 131-133 those are scheduled simultaneously by the BS 110 via a single DCI, all the cells 131-133 can be configured with the same resource allocation type, i.e., one of resourceAllocation ENUMERATED {resourceAllocationType0, resourceAllocationType1, dynamicSwitch}, where resourceAllocationType0 represents a bitmap, resourceAllocationType1 represents a range length that tells the UE 120 which Physical Resource Block (PRB) to start and how many PRBs to transmit, and dynamicSwitch can trigger dynamically switching between resourceAllocationType0 and resourceAllocationType1. Alternatively, for each cell, different resource allocation type can be configured by the BS 110.

In some embodiments, a single FDRA field may be included in the single DCI. In this case, the UE 120 may assume to be scheduled with the same FDRA for the PUSCH in each cell that is scheduled simultaneously. When the sizes of active Bandwidth Part (BWP) of different CCs are different, the DCI size can be aligned. For example, if a second CC requires less number of bits in terms of FDRA than the current CC, truncation may be applied, e.g., the Most Significant Bit (MSB) of the FDRA field may be discarded. Alternatively or in addition, if a second CC requires more number bits in terms of FDRA than the current CC, append may be applied, e.g., zero is happened to the MSB of the FDRA field.

In some embodiments, multiple FDRA fields may be included in the single DCI. Each FDRA may be used for the PUSCH corresponding to different scheduled cells 131-133.

Alternatively or in addition, a Time Domain Resource Assignment (TDRA) field in the DCI may be configured for scheduling uplink channels such as, but not limited to, PUSCH on multiple cells.

In some embodiments, a single TDRA field may be included in the single DCI. In this case, the UE 120 may assume to be scheduled with the same TDRA for the PUSCH in each cell that is scheduled simultaneously.

In some embodiments, multiple TDRA fields may be included in the single DCI. Each TDRA may be used for the PUSCH corresponding to different scheduled cells 131-133.

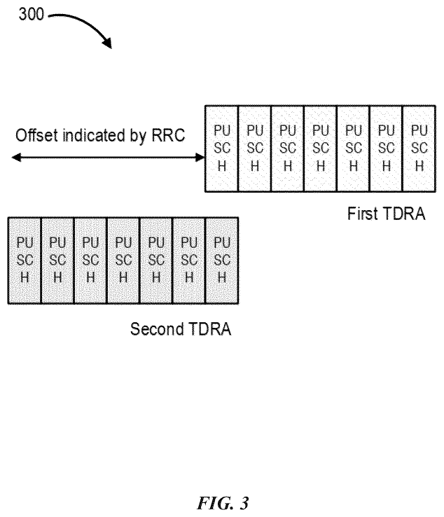

Reference is now made to FIG. 3. FIG. 3 illustrates a schematic diagram 300 of an offset of starting symbols between a first cell 131 and a second cell 132 of the scheduled cells. The symbols may be Orthogonal Frequency Division Multiplexing (OFDM) symbols.

In some embodiments, in the case that a single TDRA field is included in the single DCI, the BS 110 may configure via RRC how to derive a second TDRA (e.g., for the second cell 132) from the first TDRA (e.g., for the first cell 131). In FIG. 3, it is assumes that the following are the same among all the CCs scheduled simultaneously: (1) mapping types, i.e., mappingType ENUMERATED {typeA, typeB}, and (2) the duration of the PUSCHs, i.e., the number of the symbols. For example, FIG. 3 shows that the duration of the PUSCHs for both the first cell 131 and the second cell 132 is 7 symbols. This is for purpose of illustration without suggesting any limitations. As shown in FIG. 3, the offset of the starting symbols between the first cell 131 and the second cell 132 is 6 symbols. Therefore, the second TDRA may has the same mapping type as the first TDRA, 7 symbols duration, and 6 symbols offset of the starting symbol from that of the first TDRA. By this way, the UE 120 may derive the second TDRA for the second cell 132 from the first TDRA for the first cell 131.

In some embodiments, the network (NW) e.g., the BS 110, may configure a TDRA table. In the TDRA table, for each TDRA codepoint, NW may configure the TDRA of each scheduled cell. One specific example of the TDRA table is illustrated as below Table 1.

TABLE 1

| TDRA field | Assume a single DCI schedules 3 cells | | |
|---|---|---|---|
| codepoint | Cell 131 | Cell 132 | Cell 133 |
| codepoint 0 | K0 = 1 | K0 = 1 | K0 = 1 |
| | mapping Type = typeA | mapping Type = typeA | mapping Type = typeA |
| | startSymbolAndLength = 10 | startSymbolAndLength = 10 | startSymbolAndLength = 10 |
| Codepoint 1 | K0 = 1 | K0 = 2 | K0 = 3 |
| | mapping Type = typeA | mapping Type = typeA | mapping Type = typeA |
| | startSymbolAndLength = 10 | startSymbolAndLength = 24 | startSymbolAndLength = 30 |

. . .

| | | | |
|---|---|---|---|
| Codepoint N − 1 | K0 = 1 | K0 = 2 | K0 = 1 |
| | mapping Type = typeA | mapping Type = typeB | mapping Type = typeA |
| | startSymbolAndLength = 10 | startSymbolAndLength = 80 | startSymbolAndLength = 10 |

For the TDRA, it may contain 3 informations. The first one may be a mapping type. The second one may be duration, which is a part of the startSymbolAndLength in the table. The third one may be offsets, which is split into two parts. One part may be KO in the table, which represents a slot offset. For example, the BS 110 may tell the UE 120 the number of slots that it may wait until it can transmit in the PUSCHs. Another part of the offsets may be a symbol offset within the slots, which is another part of the startSymbolAndLength in the table.

Accordingly, the mapping type of the TDRA can be configured by the mappingType in the table. The duration of the TDRA can be configured by the length part of the startSymbolAndLength in the table. The offsets of the TDRA can be by the KO and the startSymbol part of the startSymbolAndLength in the table. In some embodiments, the TDRA table can be configured by the BS 110 over RRC and the BS 110 can tell the UE 120 through RRC for scheduling PUSCH transmissions on the multiple cells 131-133.

Note that, the number of scheduled cells and fields in Table 1 are shown only for the purpose of illustration without suggesting any limitations. The BS 110 can configure a larger TDRA table for more scheduling flexible. Alternatively, the BS 110 can configure a smaller TDRA table to reduce the scheduling flexibility but also reduce the DCI overhead. Such modifications, variations, and alternative configurations would be within the spirit and scope of embodiments of the present disclosure.

Alternatively or in addition, a Sounding Reference Signal (SRS) resource indicator field in the DCI may be configured for scheduling uplink channels such as, but not limited to, PUSCH on multiple cells.

In some embodiments, for all the cells 131-133 scheduled by the same UL DCI, Either all of them may be configured with codeBook PUSCH operations, or all of them may be configured with nonCodeBook PUSCH operations. Alternatively, some cells of the scheduled cells 131-133 may be configured with codeBook PUSCH operations, and other cells can be configured with nonCodeBook PUSCH operations.

In some embodiments, multiple SRS resource indicator fields may be included in the single DCI. Each SRS resource indicator may correspond to one scheduled cell.

In some embodiments, in Frequency Range 2 (FR2), when multiple SRS resource indicators can be indicated corresponding to different scheduled cells 131-133, spatial relationship consistency may need to be ensured when PUSCHs are transmitted at the same time. For example, different SRS resource indicators in the same DCI corresponding to different scheduled cells 131-133 may have the same spatial filter (analog beam) for UL transmissions at least for all the scheduled cells in the same band (i.e., intra-band Carrier Aggregation (CA)). Alternatively, when the UE 120 indicates that it only supports common beam management (CBM) for the corresponding band combination, different SRS resource indicators corresponding to different scheduled cells 131-133 may have the same spatial filter for UL transmissions for scheduled cells in different band (i.e., inter-band CA).

Alternatively or in addition, a Channel State Information (CSI) request field in the DCI may be configured for scheduling uplink channels such as, but not limited to, PUSCH on multiple cells.

In some embodiments, a single CSI request field may be included in the single DCI. In some embodiments, multiple CSI request fields may be included in the single DCI. The UE 120 may transmit in PUSCHs on multiple cells 131-133 based on the CSI request field(s) in the single DCI, which will be described below.

Alternatively or in addition, a UL Shared Channel (UL-SCH) indicator field in the DCI may be configured for scheduling uplink channels such as, but not limited to, PUSCH on multiple cells.

In some embodiments, when a single DCI is used to schedule PUSCH transmissions on the multiple cells 131-133, the UL-SCH indicator field may be configured with 0 bit. Alternatively, when a single DCI is used to schedule PUSCH transmissions on the multiple cells 131-133, the UL-SCH indicator filed can be configured with more than 0 bit. For example, the UL-SCH indicator filed may be 1 bit, and the same UL-SCH indicator may apply to all the scheduled cells 131-133. Alternatively, the UL-SCH indicator filed may be N bits, where 1 bit of the N bits may be used for each scheduled cells 131-133 and N may be the largest number of cells that can be scheduled by the single DCI or N may be the number of cells corresponding to the “Carrier indicator” field.

In general, there may be two approaches for tradeoff between the scheduling flexibility and the DCI size reduction. One approach may be that a single DCI field is used assuming the UE 120 applies the same field to all the scheduled cells 131-133. Another approach may be that multiple DCI field is used, one for each scheduled cell. In some embodiments, These two approaches may be independently configured for each of the following fields: Frequency hopping flag, Modulation and coding scheme, New data indicator, Redundancy version, Hybrid Automatic Repeat reQuest (HARQ) process number, Transmit Power Control (TPC) command for the PUSCHs, Precoding information and number of layers, Antenna ports, SRS request, Phase Tracking Reference Signal-Demodulation Reference Signal (PTRS-DMRS) association, DMRS sequence initialization, Code Block Group (CBG) transmission information (CBGTI), Priority, Invalid symbol pattern indicator, Primary Cell (SCell) dormancy indication and so on.

Note that, the above fields are listed only for the purpose of illustration without suggesting any limitations. Any other suitable fields in for example DCI Format 0_1 and 0_2 or any suitable new fields can also be adopted to design the DCI for supporting a single DCI scheduling uplink channels such as, but not limited to, PUSCH on multiple cells. Such modifications, variations, and alternative configurations would be within the spirit and scope of embodiments of the present disclosure.

Reference is still made to FIG. 2. In the signaling flow 200, the BS 110 transmits the configured single DCI to the UE 120 over a PDCCH. After receiving the configured DCI, the UE 120 transmits 230 in PUSCHs on multiple cells 131-133 based on the configuration information included in the single DCI.

In some embodiments, the UE 120 may transmit in PUSCHs on multiple cells 131-133 based on a new DCI that may be defined based on a new RNTI, e.g., MC-RNTI. For example, the CRC of the new DCI may be scrambled by the MC-RNTI.

In some embodiments, the UE 120 may transmit in PUSCHs on multiple cells 131-133 based on a new DCI format, e.g., the DCI format 0_3. By defining the DCI format 0_3, each DCI field in the DCI format can be designed to indicate the scheduling information of multiple scheduled cells simultaneously. In this way, the UE 120 may transmit in PUSCHs on multiple cells 131-133 based on scheduling information of the multiple cells indicated by each field of the single DCI.

In some embodiments, the UE 120 may transmit in PUSCHs on multiple cells 131-133 based on a single DCI that may be formed by concatenated the DCI from multiple cells.

Alternatively or in addition, the UE 120 may transmit in PUSCHs on multiple cells 131-133 based on a UL indicator field in the single DCI.

In some embodiments, the single DCI may include a single “UL/SUL indicator” field. The single “UL/SUL indicator” field may comprise a NUL indicator or a SUL indicator. Based on the NUL indicator in the UL indicator field, the UE 120 may transmit over NUL on multiple cells 131-133. Alternatively, based on the SUL indicator in the UL indicator field, the UE 120 may transmit over SUL on multiple cells 131-133. Alternatively, for the schedule cell that is not configured with SUL, if the “UL/SUL indicator” field is indicated as SUL, the UE 120 may still transmit over NUL, or alternatively, the UE 120 may drop the PUSCH transmission.

In some embodiments, the single DCI may include multiple “UL/SUL indicator” fields. Each UL/SUL indicator may be used for the PUSCH corresponding to different scheduled cells 131-133. In this case, the number of bits of the “UL/SUL indicator” fields may be configured as described above.

Alternatively or in addition, the UE 120 may transmit in PUSCHs on multiple cells 131-133 based on a FDRA field in the single DCI.

In some embodiments, the UE 120 may transmit in PUSCHs on all the multiple cells 131-133 with the same resource allocation type indicated by a single FDRA field in the single DCI. For example, the same resource allocation type may be one of resourceAllocation ENUMERATED {resourceAllocationType0, resourceAllocationType1, dynamicSwitch}, where resourceAllocationType0 represents a bitmap, resourceAllocationType1 represents a range length that tells the UE 120 which Physical Resource Block (PRB) to start and how many PRBs to transmit, and dynamicSwitch can trigger dynamically switching between resourceAllocationType0 and resourceAllocationType1. Alternatively, the UE 120 may transmit in a PUSCH on each of the multiple cells 131-133 with a resource allocation type indicated by one of multiple FDRA fields in the single DCI.

In some embodiments, in the case a single FDRA field included in the single DCI, the UE 120 may assume to be scheduled with the same FDRA for the PUSCH in each cell that is scheduled simultaneously. When the sizes of active BWP of different CCs are different, the DCI size can be aligned as described above.

Alternatively or in addition, the UE 120 may transmit in PUSCHs on multiple cells 131-133 based on a TDRA field in the single DCI.

In some embodiments, the single DCI may include a single TDRA field. In this case, the UE 120 may transmit in PUSCHs on multiple cells 131-133 with the same TDRA indicated by the single TDRA field. Alternatively, the single DCI may include multiple TDRA fields, and each TDRA may be used for the PUSCH corresponding to different scheduled cells 131-133.

In some embodiments, in the case that the single DCI includes a single TDRA field, the UE 120 may determine an offset of the starting symbols that may be configured by the BS 110 via RRC as shown in FIG. 3. By assuming that the mapping types and duration of the PUSCHs are the same among all the CCs scheduled simultaneously, the UE 120 may derive the second TDRA for the second cell 132 from the first TDRA for the first cell 131 based on the determined offset of the starting symbols.

In some embodiments, the UE 120 may transmit in PUSCHs on multiple cells 131-133 with the TDRA that is configured form the TDRA table, as described above by referred to Table 1.

Alternatively or in addition, the UE 120 may transmit in PUSCHs on multiple cells 131-133 based on a SRS resource indicator field in the single DCI.

In some embodiments, the UE 120 may transmit on all the multiple cells 131-133 with a CodeBook PUSCH operation or a nonCodeBook PUSCH operation indicated by a single SRS resource indicator field in the single DCI. Alternatively, the UE 120 may transmit on some cells of the multiple cells 131-133 with the CodeBook PUSCH operation and transmit on some cells of the multiple cells 131-133 with the nonCodeBook PUSCH operation based on multiple SRS resource indicator fields in the single DCI. Each SRS resource indicator in the multiple SRS resource indicator fields may correspond to one scheduled cell.

In some embodiments, when the UE 120 determine that PUSCHs are to be transmitted at the same time, spatial relationship consistency may need to be ensured. In some embodiments, the UE 120 may transmit in the PUSCHs with the same spatial filter (analog beam) at least for all the scheduled cells in the same band (i.e., intra-band CA). Alternatively, when the UE 120 indicates that it only supports common beam management (CBM) for the corresponding band combination, the UE 120 may transmit in the PUSCHs with the same spatial filter for scheduled cells in different band (i.e., inter-band CA).

Alternatively or in addition, the UE 120 may transmit in PUSCHs on multiple cells 131-133 based on a CSI request field in the single DCI.

In some embodiments, the single DCI may include a single CSI request field. In this case, when the UE 120 is scheduled to transmit in multiple PUSCHs, the UE 120 may transmit an aperiodic CSI in all the PUSCHs on all the scheduled cells 131-133. Alternatively, the UE 120 may only transmit the aperiodic CSI in the PUSCH on one of the schedule cells 131-133.

In some embodiments, in the case that the single DCI includes a single CSI request field, when the UE 120 only transmits the aperiodic CSI in the PUSCH on one of the schedule cells 131-133, the UE 120 may determine which cell to use to transmits the aperiodic CSI. For example, the UE 120 may determine a single cell to transmit based on the cell with the lowest frequency. Alternatively, the UE 120 may determine a single cell to transmit based on the cell that PUSCH transmission is not cancelled, e.g., due to duplexing direction conflict, UL preemption, etc. Alternatively, the UE 120 may determine a single cell to transmit based on the cell that has higher priority. Alternatively, the UE 120 may determine a single cell to transmit based on the serving cell ID. Alternatively, the UE 120 may determine a single cell to transmit based on relative timing of the PUSCHs. For example, the UE 120 may determine a cell that the PUSCH is scheduled to be transmitted the earliest, or alternatively, the UE 120 may determine a cell that the PUSCH meets the aperiodic CSI processing time requirement.

Alternatively or in addition, the UE 120 may transmit in PUSCHs on multiple cells 131-133 based on a UL-SCH indicator field in the single DCI.

In some embodiments, when a single DCI is used to scheduled UL data in PUSCH transmissions on multiple cells 131-133, and the data in UE buffer of the UE 120 is not enough to fill all the PUSCHs in all the scheduled cells 131-133, the UE 120 may append dummy data, e.g., all “0” or “1” and still transmit on all the scheduled cells 131-133. Alternatively, for the scheduled cell(s) that the UE 120 has no data, the UE 120 may choose not to transmit in PUSCHs at all for that cell(s).

In some embodiments, when the UE 120 chooses not to transmit in PUSCHs at all for that cell(s), the UE 120 may choose which cell to transmit PUSCH based on UE implementation. Alternatively, the UE 120 may omit the PUSCH transmission on the cell that has lower priority. In some embodiments, the priority of each cell may be configured by the network (e.g., the BS 110) via RRC. Alternatively, the priority of each cell may depends on one or more factors, such as serving cell ID, Time Division Duplex (TDD) or Frequency Division Duplex (FDD) band, frequency of each of the multiple cells, PUSCH priority, and time of scheduled PUSCH transmission.

In general, the single DCI may include a single DCI field assuming that the ULE 120 applies the same field to all the scheduled cells 131-133, or alternatively, the single DCI may include multiple DCI field with one for each scheduled cell. The DCI field(s) may be independently configured from one or more of the following fields: Frequency hopping flag, Modulation and coding scheme, New data indicator, Redundancy version, Hybrid Automatic Repeat reQuest (HARQ) process number, Transmit Power Control (TPC) command for the PUSCHs, Precoding information and number of layers, Antenna ports, SRS request, Phase Tracking Reference Signal-Demodulation Reference Signal (PTRS-DMRS) association, DMRS sequence initialization, Code Block Group (CBG) transmission information (CBGTI), Priority, Invalid symbol pattern indicator, Primary Cell (SCell) dormancy indication and so on.

As indicated above, the fields are listed only for the purpose of illustration without suggesting any limitations.

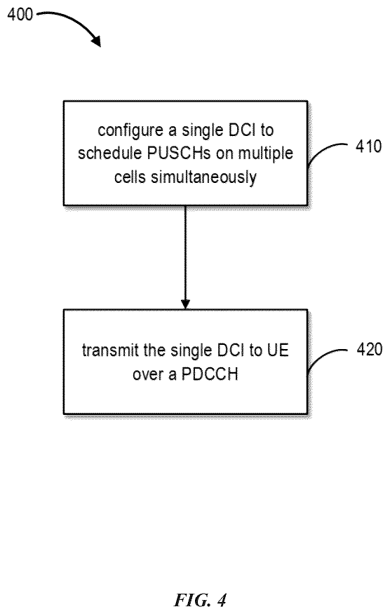

FIG. 4 illustrates a flowchart 400 illustrating an example method of supporting a single DCI scheduling uplink channels such as, but not limited to, PUSCH on multiple cells 131-133 performed by the BS 110 according to some embodiments of the present disclosure. For the purpose of discussion, the method 400 will be described with reference to FIGS. 1-3. The method 400 may involve the BS 110 shown in FIG. 1. It is to be understood that the method 400 may include additional blocks not shown and/or may omit some shown blocks, and the scope of the present disclosure is not limited in this regard.

At block 410, the BS 110 configures a single DCI to schedule PUSCHs on multiple cells simultaneously.

In some embodiments, the BS 110 may define a MC-RNTI via RRC and scramble a CRC of the single DCI using the defined MC-RNTI.

In some embodiments, the BS 110 may define a DCI format with each field of the single DCI designed to indicate scheduling information of the multiple cells 131-133.

In some embodiments, the BS 110 may configure a field of the single DCI for each of the multiple cells. A size of the field may be configured independently for each of the multiple cells. Moreover, the BS 110 may concatenate the field for each of the multiple cells to form the single DCI.

In some embodiments, the BS 110 may configure a UL indicator field in the single DCI to schedule the PUSCHs on the multiple cells. The UL indicator field may comprise a NUL indicator and/or a SUL indicator.

In some embodiments, the number of bits of the UL indicator field may be determined based on one of the number of the multiple cells, the number of SULs on the multiple cells, or the number of SULs on cells of the multiple cells that is indicated by a carrier indicator in the single DCI.

In some embodiments, the BS 110 may configure a single FDRA field in the DCI for scheduling the PUSCHs on the multiple cells. The single FDRA field may indicate the same resource allocation type for all the multiple cells.

In some embodiments, the BS 110 may align a size of the single DCI by applying a truncation or append to the FDRA field.

In some embodiments, the BS 110 may configure multiple TDRA fields in the single DCI for scheduling the PUSCHs on the multiple cells. Each of the multiple TDRA fields may indicate a respective time domain resource for on one of the multiple cells.

In some embodiments, the BS 110 may configure a single TDRA field in the single DCI for scheduling the PUSCHs on the multiple cells. The single TDRA field may indicate the same time domain resource for all the multiple cells.

In some embodiments, the BS 110 may configure an offset of starting symbols between a first and second cells of the multiple cells based on a determination of the following being the same: mapping types of the first and second cells, and durations of the PUSCHs on the first and second cells.

In some embodiments, the BS 110 may configure a TDRA table by determining at least the following information at each TDRA codepoint: a slot offset, a mapping type for each of the multiple cells, and StartSymbolAndLength consisting of a duration of the PUSCH on each of the multiple cells and a start symbol. Moreover, the BS 110 may configure each of the multiple TDRA fields for one of the multiple cells based on the TDRA table.

In some embodiments, the BS 110 may configure a single SRS resource indicator field in the single DCI. The single SRS resource indicator field may indicate that all the multiple cells are configured with a CodeBook PUSCH operation or a nonCodeBook PUSCH operation.

In some embodiments, the BS 110 may configure multiple SRS resource indicator fields in the single DCI. Each of the multiple SRS resource indicator fields may be used for one of the multiple cells to indicate a CodeBook PUSCH operation or a nonCodeBook PUSCH operation.

In some embodiments, the BS 110 may configure a UL-SCH indicator field in the single DCI. The UL-SCH indicator field may be configured with one of the following number of bits: 0; 1, indicating whether UL data transmission is scheduled for all of the multiple cells; the number of the multiple cells, where each bit may indicate whether UL data transmission is scheduled for the corresponding cell in the multiple cells; and the number of cells of the multiple cells corresponding to a carrier indicator in the single DCI, where 1 bit may indicate whether UL data transmission is scheduled for each of the multiple cells.

In some embodiments, the BS 110 may configure one or more fields in the single DCI for each of the multiple cells. The one or more fields may be determined from at least the following fields: Frequency hopping flag, Modulation and coding scheme, New data indicator, Redundancy version, Hybrid Automatic Repeat reQuest (HARQ) process number, Transmit Power Control (TPC) command for the PUSCHs, Precoding information and number of layers, Antenna ports, SRS request, Phase Tracking Reference Signal-Demodulation Reference Signal (PTRS-DMRS) association, DMRS sequence initialization, Code Block Group (CBG) transmission information (CBGTI), Priority, Invalid symbol pattern indicator, Primary Cell (SCell) dormancy indication and so on.

At block 420, the BS 110 transmits the configured single DCI to the UE 120 over a PDCCH.

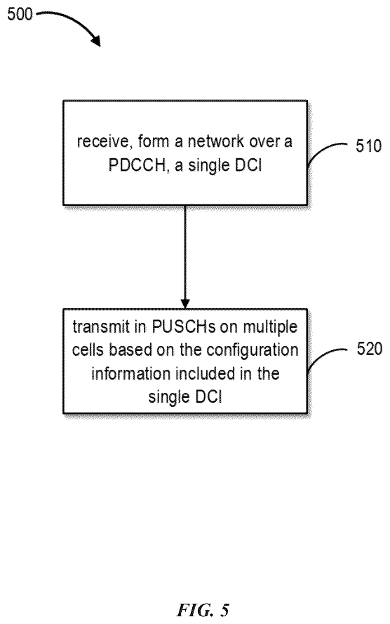

FIG. 5 illustrates a flowchart 500 illustrating an example method of supporting a single DCI scheduling uplink channels such as, but not limited to, PUSCH on multiple cells 131-133 performed by the UE 120 according to some embodiments of the present disclosure. For the purpose of discussion, the method 500 will be described with reference to FIGS. 1-3. The method 500 may involve the UE 120 shown in FIG. 1. It is to be understood that the method 500 may include additional blocks not shown and/or may omit some shown blocks, and the scope of the present disclosure is not limited in this regard.

At block 510, the UE 120 receives, form a network (e.g., the BS 110) over a PDCCH, a single DCI.

At block 520, the UE 120 transmits in PUSCHs on multiple cells based on the configuration information included in the single DCI.

In some embodiments, the UE 120 may transmit in the PUSCHs on the multiple cells based on scheduling information of the multiple cells indicated by each field of the single DCI.

In some embodiments, the single DCI may comprise an UL indicator field. The UL indicator field may comprise a NUL indicator and/or a SUL indicator. Moreover, the UE 120 may transmit over the NUL on the multiple cells based on the NUL indicator in the UL indicator field. Alternatively, the UE 120 may transmit over the SUL on the multiple cells based on the SUL indicator in the UL indicator field. Alternatively, the UE 120 may transmit over the NUL on a cell of the multiple cells that indicate by the NUL indicator and transmitting over the SUL on a cell of the multiple cells that indicate by the SUL indicator.

In some embodiments, for a cell of the multiple cells that is not configured with the SUL, in response to a determination that the cell is indicated by the SUL indicator in the UL indicator field, the UE 120 may transmit over the NUL, or alternatively, the UE 120 may drop the PUSCH transmission.

In some embodiments, the UE 120 may transmit in the PUSCHs on the multiple cells with the same resource allocation type indicated by a single FDRA field in the single DCI. Alternatively, the UE 120 may transmit in a PUSCH on each of the multiple cells with a resource allocation type indicated by one of multiple FDRA fields in the single DCI.

In some embodiments, the UE 120 may transmit in a PUSCH on each of the multiple cells with a respective time domain resource indicated by one of multiple TDRA fields in the single DCI.

In some embodiments, the UE 120 may determine an offset of starting symbols between a first and second cells of the multiple cells based on the configuration information included in the single DCI. Moreover, the UE 120 may derive a second time domain resource for the second cell from a first time domain resource for the first cell based on the determined offset.

In some embodiments, the UE 120 may receive a TDRA table from the network via RRC, and the multiple TDRA fields in the single DCI may be configured based on the TDRA table.

In some embodiments, the UE 120 may transmit on all the multiple cells 131-133 with a CodeBook PUSCH operation or a nonCodeBook PUSCH operation indicated by a single SRS resource indicator field in the single DCI.

In some embodiments, the UE 120 may transmit on each of the multiple cells with a CodeBook PUSCH operation or a nonCodeBook PUSCH operation based on one of multiple SRS resource indicator fields in the single DCI.

In some embodiments, the UE 120 may determine to transmit in the PUSCHs on the multiple cells at the same time. Moreover, the UE 120 may transmit in the PUSCHs on the multiple cells in the same band or in different band with the same spatial filter, so as to ensure spatial relationship consistency.

In some embodiments, the UE 120 may transmit an aperiodic CSI in the PUSCHs on all the multiple cells based on a single CSI request field in the single DCI.

In some embodiments, the UE 120 may transmit an aperiodic CSI in a PUSCH on one of the multiple cells based on the single CSI request field in the single DCI.

In some embodiments, the UE 120 may determine the one of the multiple cells from at least one of a cell with the lowest frequency, a cell that PUSCH transmission is not cancelled, a cell that has a higher priority, a cell that has serving cell ID, a cell that a PUSCH is scheduled to be transmitted the earliest, and a cell that a PUSCH meets an aperiodic CSI processing time requirement.

In some embodiments, the UE 120 may transmit in the PUSCHs on the multiple cells based on a UL-SCH indicator field in the single DCI.

In some embodiments, based on a determination that data in UE buffer is not enough to fill the PUSCHs on all the multiple cells, the UE 120 may append dummy data and still transmitting in the PUSCHs on all the multiple cells. Alternatively, the UE 120 may not transmit in a PUSCH on a cell of the multiple cells that the UE has no data.

In some embodiments, in response to not transmitting in the PUSCH on the cell of the multiple cells that the UE has no data, the UE 120 may choose a cell from the multiple cells for PUSCH transmission based on UE implementation. Alternatively, the UE 120 may omit PUSCH transmission on a cell of the multiple cells that has a lower priority.

In some embodiments, a priority of each of the multiple cells may be configured by the network via RRC. Alternatively, the priority of each of the multiple cells depends on at least one of the following factors: serving cell ID, Time Division Duplex (TDD) or Frequency Division Duplex (FDD) band, frequency of each of the multiple cells, PUSCH priority, and time of scheduled PUSCH transmission.

In some embodiments, the UE 120 may transmit in the PUSCHs on multiple cells based on one or more fields in the single DCI. The one or more fields may be determined from at least the following fields: Frequency hopping flag, Modulation and coding scheme, New data indicator, Redundancy version, Hybrid Automatic Repeat reQuest (HARQ) process number, Transmit Power Control (TPC) command for the PUSCHs, Precoding information and number of layers, Antenna ports, SRS request, Phase Tracking Reference Signal-Demodulation Reference Signal (PTRS-DMRS) association, DMRS sequence initialization, Code Block Group (CBG) transmission information (CBGTI), Priority, Invalid symbol pattern indicator, Primary Cell (SCell) dormancy indication and so on.

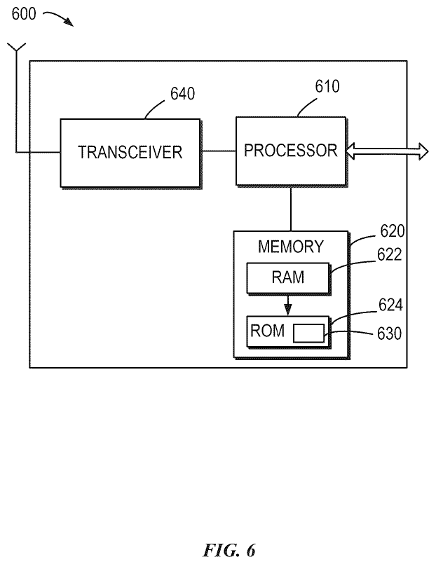

FIG. 6 is a simplified block diagram of a device 600 that is suitable for implementing embodiments of the present disclosure. For example, the BS 110 and the ULE 120 can be implemented by the device 600. As shown, the device 600 includes a processor 610, a memory 620 coupled to the processor 610, and a transceiver 640 coupled to the processor 610.

The transceiver 640 is for bidirectional communications. The transceiver 640 is coupled to at least one antenna to facilitate communication. The transceiver 640 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 4-5. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4 and/or the method 500 as described above with reference to FIG. 5.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A processor of a base station (BS) configured to perform operations comprising:
configuring a single Downlink Control Information (DCI) to schedule Physical Uplink Shared Channels (PUSCHs) on multiple cells simultaneously; and
transmitting the single DCI to a user equipment (UE) over a Physical Downlink Control Channel (PDCCH).

2. The processor of claim 1, wherein configuring the single DCI comprises:
defining a Multiple Cells Radio Network Temporary Identifier (MC-RNTI) via Radio Resource Control (RRC); and
scrambling a Cyclic Redundancy Check (CRC) of the single DCI using the defined MC-RNTI.

3. The processor of claim 1, wherein configuring the single DCI comprises:
configuring a field of the single DCI for each of the multiple cells, wherein a size of the field is configured independently for each of the multiple cells; and
concatenating the field for each of the multiple cells to form the single DCI.

4. The processor of claim 1, wherein configuring the single DCI comprises:
configuring an uplink (UL) indicator field in the single DCI to schedule the PUSCHs on the multiple cells,
wherein:
the UL indicator field comprises a normal uplink (NUL) indicator and/or a supplemental uplink (SUL) indicator, and
the number of bits of the UL indicator field is determined based on one of the following:
the number of the multiple cells;
the number of SULs on the multiple cells; or
the number of SULs on cells of the multiple cells that is indicated by a carrier indicator in the single DCI.

5. The processor of claim 1, wherein configuring the single DCI comprises:
configuring a single Frequency Domain Resource Assignment (FDRA) field in the DCI for scheduling the PUSCHs on the multiple cells, wherein the single FDRA field indicates the same resource allocation type for all of the multiple cells; and
aligning a size of the single DCI by applying a truncation or append to the FDRA field.

6. The processor of claim 1, wherein configuring the single DCI comprises:
configuring multiple FDRA fields in the single DCI for scheduling the PUSCHs on the multiple cells, wherein each of the multiple FDRA fields indicates a respective resource allocation type for one of the multiple cells.

7. The processor of claim 1, wherein configuring the single DCI comprises:
configuring multiple TDRA fields in the single DCI for scheduling the PUSCHs on the multiple cells, wherein each of the multiple TDRA fields indicates a respective time domain resource for one of the multiple cells.

8. The processor of claim 1, wherein configuring the single DCI comprises:
configuring a single Time Domain Resource Assignment (TDRA) field in the single DCI for scheduling the PUSCHs on the multiple cells, wherein the single TDRA field indicates the same time domain resource for all of the multiple cells.

9. The processor of claim 8, wherein configuring the single DCI further comprises:
configuring an offset of starting symbols between a first and second cells of the multiple cells based on a determination of the following being the same:
mapping types of the first and second cells; and
durations of the PUSCHs on the first and second cells.

10. The processor of claim 8, wherein configuring the single DCI further comprises:
configuring a TDRA table by determining at least the following information at each TDRA codepoint:
a slot offset,
a mapping type for each of the multiple cells, and
StartSymbolAndLength consisting of a duration of the PUSCH on each of the multiple cells and a start symbol; and
configuring each of the multiple TDRA fields for one of the multiple cells based on the TDRA table.

11. A processor of a user equipment (UE) configured to perform operations comprising:
receiving, form a network over a Physical Downlink Control Channel (PDCCH), a single Downlink Control Information (DCI); and
transmitting in Physical Uplink Shared Channels (PUSCHs) on multiple cells based on the configuration information included in the single DCI.

12. The processor of claim 11, wherein the single DCI comprises an uplink (UL) indicator field comprising a normal uplink (NUL) indicator and/or a supplemental uplink (SUL) indicator, and wherein transmitting in the PUSCHs on multiple cells based on the configuration information included in the single DCI comprises one of the following:
transmitting over the NUL on the multiple cells based on the NUL indicator in the UL indicator field;
transmitting over the SUL on the multiple cells based on the SUL indicator in the UL indicator field; or
transmitting over the NUL on a cell of the multiple cells that indicate by the NUL indicator and transmitting over the SUL on a cell of the multiple cells that indicate by the SUL indicator.

13. The processor of claim 12, for a cell of the multiple cells that is not configured with the SUL, in response to a determination that the cell is indicated by the SUL indicator in the UL indicator field, transmitting in the PUSCHs on the cell comprises one of the following:
transmitting over the NUL; or
dropping the PUSCH transmission.

14. The processor of claim 11, wherein transmitting in the PUSCHs on the multiple cells based on the configuration information included in the single DCI comprises one of the following:
transmitting in the PUSCHs on the multiple cells with the same resource allocation type indicated by a single Frequency Domain Resource Assignment (FDRA) field in the single DCI; or
transmitting in a PUSCH on each of the multiple cells with a resource allocation type indicated by one of multiple FDRA fields in the single DCI.

15. The processor of claim 11, wherein transmitting in the PUSCHs on the multiple cells based on the configuration information included in the single DCI comprises:
transmitting in the PUSCHs on the multiple cells with the same time domain resource indicated by a single Time Domain Resource Assignment (TDRA) field in the single DCI.

16. The processor of claim 11, wherein transmitting in the PUSCHs on the multiple cells based on the configuration information included in the single DCI comprises:
transmitting in a PUSCH on each of the multiple cells with a respective time domain resource indicated by one of multiple TDRA fields in the single DCI;
determining an offset of starting symbols between a first and second cells of the multiple cells based on the configuration information included in the single DCI; and
deriving a second time domain resource for the second cell from a first time domain resource for the first cell based on the determined offset.

17. The processor of claim 11, wherein transmitting in the PUSCHs on the multiple cells based on the configuration information included in the single DCI comprises:
transmitting on all the multiple cells with a CodeBook PUSCH operation or a nonCodeBook PUSCH operation indicated by a single Sounding Reference Signal (SRS) resource indicator field in the single DCI.

18. The processor of claim 11, wherein transmitting in the PUSCHs on the multiple cells based on the configuration information included in the single DCI comprises:
transmitting on each of the multiple cells with a CodeBook PUSCH operation or a nonCodeBook PUSCH operation based on one of multiple SRS resource indicator fields in the single DCI;
determining to transmit in the PUSCHs on the multiple cells at the same time; and
transmitting in the PUSCHs on the multiple cells in the same band or in different band with the same spatial filter, so as to ensure spatial relationship consistency.

19. The processor of claim 11, wherein transmitting in the PUSCHs on the multiple cells based on the configuration information included in the single DCI comprises:
transmitting an aperiodic Channel State Information (CSI) in the PUSCHs on all the multiple cells based on a single CSI request field in the single DCI.

20. The processor of claim 11, wherein transmitting in the PUSCHs on the multiple cells based on the configuration information included in the single DCI comprises:
transmitting an aperiodic CSI in a PUSCH on one of the multiple cells based on the single CSI request field in the single DCI,
wherein the processor is configured to determine the one of the multiple cells from at least one of the following:
a cell with the lowest frequency,
a cell that PUSCH transmission is not cancelled,
a cell that has a higher priority,
a cell that has smallest serving cell ID,
a cell that a PUSCH is scheduled to be transmitted the earliest, and
a cell that a PUSCH meets an aperiodic CSI processing time requirement.
